(19) United States
(12) Patent Application Publication
(10) Pub. No.: US 2009/0092874 A1
(43) Pub. Date: Apr. 9, 2009

(54) STABLE HYDROPHILIC COATING FOR FUEL CELL COLLECTOR PLATES

(75) Inventors: Mahmoud H. Abd Elhamid, Grosse Pointe Woods, MI (US); Youssef M. Mikhail, Sterling Heights, MI (US); Gayatri Vyas Dadheech, Rochester Hills, MI (US); Curtis A. Wong, Macomb Township, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 11/867,430

(22) Filed: Oct. 4, 2007

(51) Int. Cl. H01M 8/10; H01M 8/02; H01M 8/00

(52) U.S. Cl. 429/30; 429/34; 427/115

(57) ABSTRACT

One embodiment of the invention includes a product including a fuel cell component including a coating thereon, the coating comprising nanoparticles comprising titanium oxide or titanium containing compounds derived therefrom.

### TECHNICAL FIELD

The field to which the disclosure generally relates includes fuel cell components including a coating thereon, fuel cell collector plates, fuel cell stacks and methods of making and using the same.

### BACKGROUND

The surfaces defining a reactant gas flow field of a fuel cell bipolar plate have been coated with materials to produce hydrophilic or hydrophobic surfaces.

### SUMMARY OF EXEMPLARY EMBODIMENTS OF THE INVENTION

One embodiment of the invention includes a product including a fuel cell component including a coating thereon, the coating comprising nanoparticles comprising titanium oxide or titanium containing compounds derived therefrom.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIGS. 1A-C are FESEM images of a coating of titanium oxide nanoparticles on a 304L stainless substrate according to one embodiment of the invention.

FIGS. 2A-B are photomicrographs of a cross-section of a sample showing the thickness of the as-deposited titanium oxide film according to one embodiment of the invention.

FIG. 3 illustrates a portion of a fuel cell stack according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

One embodiment of the invention includes a fuel cell component such as, but not limited to, a fuel cell bipolar plate having a reactant gas flow field formed therein as described hereafter and including a hydrophilic coating which may completely cover the surface of or may be selectively deposited on portions of the bipolar plate. The coating may include nanoparticles including titanium oxide or titanium containing compound derived therefrom. The titanium oxide may be doped with a variety of one or more elements such as but not limited to nitrogen, ruthenium, tantalum, niobium, manganese, cobalt and several metal oxides. The doping element may be selected to improve the durability or the hydrophilic properties of the coating, make the coating electrically conductive or to provide other properties as desired. In one embodiment, the channels only of the bipolar plate are coated with the nanoparticles comprising titanium oxide. One embodiment of the invention the coating includes TiOₓN_{y-1}, wherein in one embodiment, x may from 1-3, and y may range from 1-5. The titanium oxide nanoparticles are a lot more stable than silica based coatings and their microstructure are believed to be more suitable than regular silica for water management on bipolar plates or other fuel cell components. In one embodiment, substantially all of the nano particles have a size ranging from 10 to about 50 nm.

Experiments were carried out wherein a 10% suspension of titanium oxide nanoparticles in water was used to coat flat 304L stainless steel coupons. Prior to applying the coatings, the SS substrates were cleaned with wiping the area with acetone followed by wiping the substrate with methanol. Upon doing that the SS substrate are subjected to an open air plasma cleaning machine. The current and voltages applied to plasma source is in range of 2.5 to 3A with a potential of 130-150V. A nozzle with 2 mm diameter is used with a distance of 1 to 5 cm. The plasma nozzle is robotically controlled and can be programmed to get an even uniform plasma cleaning through the entire area of the substrate. The substrate preparatory process leaves the SS substrate free from any residue or contamination.

The coating was then applied to the coupons by brushing the surface of the stainless steel with the titanium oxide suspension using a brush. The coating was then dried using an air dryer for one minute. It was noted that the application of these coatings becomes very uniform if the surface are prepared well.

The coatings may also be applied by other coating technique like spraying, dipping, doctor blading, electrophoresis, In one embodiment, the coatings can be sprayed with a series of microjets covering the entire length of the substrate which are controlled by robot with a lag time of 2-5 minutes after the plasma cleaning operation.

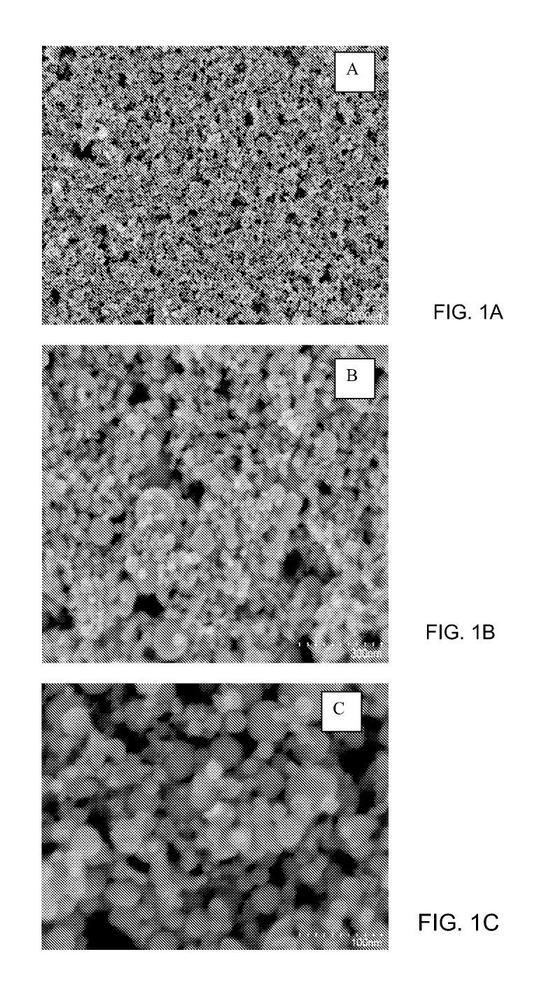

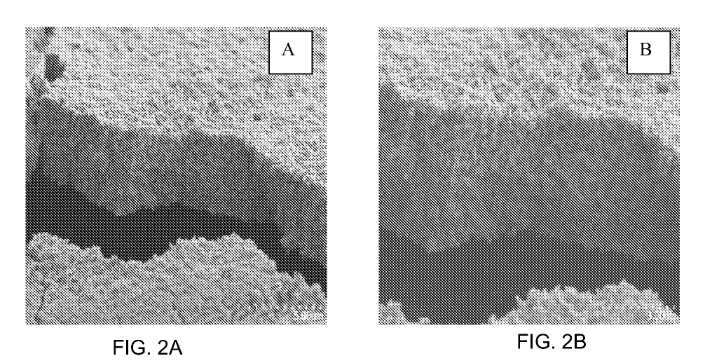

A steady state water contact angle of less than 10° was measured on the coated sample which remained constant with time upon exposure to open air environment on the lab bench top. Another sample was left soaked in water to check for the stability of the coating on the stainless steel substrate and no significant change in the coating hydrophilicity or topography was seen after one week. Single fuel cell and stack testing using this coating on stainless steel bipolar plates did not show any signs of water management issues which are normally seen when the bipolar plates are not coated with hydrophilic coatings. Further, SEM images of the as-coated stainless steel sample are shown in FIGS. 1A-C. As can be seen by FIGS. 1A-C in one embodiment this titanium oxide particle size was between 10-50 nm which presumably is one factor that contributes to the enhanced hydrophilicity of the coated surface. In one embodiment of the invention substantially all of the particles in the coating have a size ranging from about 10 to about 50 nm. In one embodiment, the coating may have a thickness ranging from about 3-5 microns as shown in FIGS. 2A-B on a stainless steel surface. In another embodiment of the invention the thickness of the coating 11 may range from about 0.5 to about 10 microns. This thickness is advantageous even if dissolution occurs in an HF environment produced by degradation of polyelectrolyte membranes used in the fuel cell. In another experiment, a coating including nanoparticles of titanium oxide was applied to a stainless steel coupon with a flow field formed therein and a 100% wicking length was observed on the channels of the flow field of the coupon demonstrating excellent hydrophilicity of the coating.

Nanoparticles including titanium oxide or derivatives thereof may be produced by a variety of process including but not limited to a sol-gel process, pyrohydrolysis, solvo-thermal, particle ALD or CVD or plasma enhanced CVD processes For example, titanium oxide nanoparticles may be produced by ALD whereby a precursor of titanium tetrachloride is used to deposit monolayers of the Titanium oxide on the substrate to be coated. Continuous deposition brings about a thicker coating with particle size in the nanometer range. Alternatively, titanium nanoparticles and derivatives thereof are available from a variety of suppliers including, but not limited to, Aldrich 10 wt % Titanium oxide suspension “catalog number. 643017”. Alternatively, a suspension of 4 wt % titania nanoparticles “Aldrich catalog number 637262” in ethanol was prepared by mixing the titania Nano particles in the ethanol solution and ultrasonating the mixture thereafter for 5 minutes. The homogenous solution prepared using this method was used to coat stainless steel substrate using by dipping the sample in the suspension and drying the coat in air or using an air dryer thereafter. The thickness of the coat can be adjusted through the brushing or the dipping process to produce a thin or thick film of the nanoparticles on the stainless steel surface.

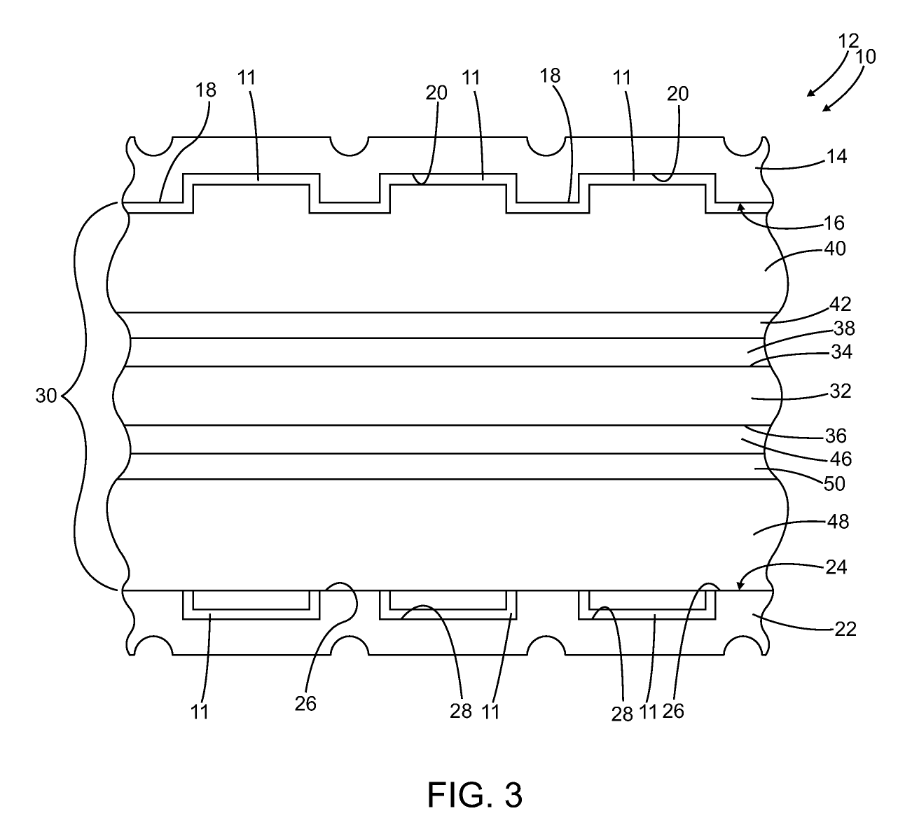

Referring now to FIG. 3, one embodiment of the invention includes a product 10 comprising a fuel cell 12. The fuel cell 12 may include a first fuel cell bipolar plate 14 including a first face 16 having a reactant gas flow field defined therein by a plurality of lands 18 and channels 20. The reactant gas flow field may deliver a fuel on one side of the bipolar plate and an oxidant on the other side of the bipolar plate.

According to one embodiment of the invention, the entire surface including the lands 18 and the channels 20 may be coated with a coating 11 including nanoparticles including titanium oxide or derivatives thereof. The fuel cell 12 may also include a second fuel cell bipolar plate 22 including a first face 24 having a reactant gas flow field defined therein by a plurality of lands 26 and channels 28. The lands 18 or 16 and the channels 20 or 28 may be formed in the bipolar plate 14 or 22 by machining, etching, stamping, molding or the like. According to another embodiment, a coating 11 including nanoparticles including titanium oxide or derivatives thereof is selectively deposited on portions of the bipolar plate 22, for example only on the surface defining the channel 28 formed in the bipolar plate 22.

A soft goods portion 30 may be provided between the first fuel cell bipolar plate 14 and the second fuel cell bipolar plate 22. The first fuel cell bipolar plate 14 and the second fuel cell bipolar plate 22 may include a variety of materials including, but not limited to, a metal, metal alloy, and/or electrically conductive composite. In one embodiment of the invention, the first fuel cell bipolar plate 14 and the second fuel cell bipolar plate 22 may be stainless steel.

The soft goods portion 30 may include a polymer electrolyte membrane 32 comprising a first face 34 and a second face 36. A cathode electrode may overlie the first face 34 of the polymer electrolyte membrane 32. A first gas diffusion media layer 40 may overlie the cathode electrode 38, and optionally a first microporous layer 42 may be interposed between the first gas diffusion media layer 40 and the cathode electrode 38. The first gas diffusion media layer 40 may be hydrophobic. The first bipolar plate 14 may overlie the first gas diffusion medium layer 40. If desired, a hydrophilic layer (not shown) may be interposed between the first fuel cell bipolar plate 14 and the first gas diffusion medium layer 40.

An anode electrode 46 may underlie the second face 36 of the polymer electrolyte membrane 32. A second gas diffusion medium layer 48 may underlie the anode layer 46, and optionally a second microporous layer 50 may be interposed between the second gas diffusion medium layer 48 and the anode electrode 46. The second gas diffusion medium layer 48 may be hydrophobic. The second fuel cell bipolar plate 22 may overlie the second gas diffusion media layer 48. If desired, a second hydrophilic layer (not shown) may be interposed between the second fuel cell bipolar plate 22 and the second gas diffusion medium layer 48.

In various embodiments, the polymer electrolyte membrane 32 may comprise a variety of different types of membranes. The polymer electrolyte membrane 32 useful in various embodiments of the invention may be an ion-conductive material. Examples of suitable membranes are disclosed in U.S. Pat. Nos. 4,272,353 and 3,134,689, and in the Journal of Power Sources, Volume 28 (1990), pages 367-387. Such membranes are also known as ion exchange resin membranes. The resins include ionic groups in their polymeric structure; one ionic component for which is fixed or retained by the polymeric matrix and at least one other ionic component being a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cationic exchange, proton conductive resins is the so-called sulfonic acid cationic exchange resin. In the sulfonic acid membranes, the cationic exchange groups are sulfonic acid groups which are attached to the polymer backbone.

The formation of these ion exchange resins into membranes or chutes is well-known to those skilled in the art. The preferred type is perfluorinated sulfonic acid polymer electrolyte in which the entire membrane structure has ionic exchange characteristics. These membranes are commercially available, and a typical example of a commercial sulfonic perfluorocarbon proton conductive membrane is sold by E. I. DuPont D Nemours & Company under the trade designation NAFION. Other such membranes are available from Asahi Glass and Asahi Chemical Company. The use of other types of membranes, such as, but not limited to, perfluorinated cation-exchange membranes, hydrocarbon based cation-exchange membranes as well as anion-exchange membranes are also within the scope of the invention.

In one embodiment, the first gas diffusion medium layer 40 or the second gas diffusion medium layer 48 may include any electrically conductive porous material. In various embodiments, the gas diffusion medium layer may include non-woven carbon fiber paper or woven carbon cloth which may be treated with a hydrophobic material, such as, but not limited to, polymers of polyvinylidene fluoride (PVDF), fluroethylene propylene, or polytetrafluoroethylene (PTFE). The gas diffusion media layer may have an average pore size ranging from 540 micrometers. The gas diffusion medium layer may have a thickness ranging from about 100 to about 500 micrometers.

In one embodiment, the electrodes (cathode layer and anode layer) may be catalyst layers which may include catalyst particles such as platinum, and an ion conductive material such as a proton conducting ionomer, intermingled with the particles. The proton conductive material may be an ionomer such as a perfluorinated sulfonic acid polymer. The catalyst materials may include metals such as platinum, palladium, and mixtures of metals such as platinum and molybdenum, platinum and cobalt, platinum and ruthenium, platinum and nickel, platinum and tin, other platinum transition-metal alloys, and other fuel cell electrocatalysts known in the art. The catalyst materials may be finely divided if desired. The catalyst materials may be unsupported or supported on a variety of materials such as but not limited to finely divided carbon particles.

In one embodiment, the cathode electrode 38 and the anode electrode 46 may be catalyst layers which may include catalyst particles such as platinum, and an ion conductive material such as a proton conducting ionomer, intermingled with the particles. The proton conductive material may be an ionomer such as a perfluorinated sulfonic acid polymer. The catalyst materials may include metals such as platinum, palladium, and mixtures of metals such as platinum and molybdenum, platinum and cobalt, platinum and ruthenium, platinum and nickel, platinum and tin, other platinum transition-metal alloys, and other fuel cell electrocatalysts known in the art. The catalyst materials may be finely divided if desired. The catalyst materials may be unsupported or supported on a variety of materials such as but not limited to finely divided carbon particles.

In one embodiment, the first microporous layer 42 or the second microporous layer 50 may be made from materials such as carbon blacks and hydrophobic constituents such as polytetrafluoroethylene (PTFE) and polyvinylidene fluoride (PVDF), and may have a thickness ranging from about 2 to about 100 micrometers. In one embodiment the microporous layer may include a plurality of particles, for example including graphitized carbon, and a binder. In one embodiment the binder may include a hydrophobic polymer such as, but not limited to, polyvinylidene fluoride (PVDF), fluoroethylene propylene (FEP), polytetrafluoroethylene (PTFE), or other organic or inorganic hydrophobic materials. The particles and binder may be included in a liquid phase which may be, for example, a mixture of an organic solvent and water to provide dispersion. In various embodiments, the solvent may include at least one of 2-propanol, 1-propanol or ethanol, etc. The dispersion may be applied to a fuel cell substrate, such as, a gas diffusion medium layer or a hydrophobic coating over the gas diffusion medium layer. In another embodiment, the dispersion may be applied to an electrode. The dispersion may be dried (by evaporating the solvent) and the resulting dried microporous layer may include 60-90 weight percent particles and 10-40 weight percent binder. In various other embodiments, the binder may range from 10-30 weight percent of the dried microporous layer.

When the terms “over”, “overlying”, “overlies”, or “under”, “underlying”, “underlies” are used with respect to the relative position of a first component or layer with respect to a second component or layer, such shall mean that the first component or layer is in direct contact with the second component or layer, or that additional layers or components are interposed between the first component or layer and the second component or layer.

The above description of embodiments of the invention is merely exemplary in nature and, thus, variations thereof are not to be regarded as a departure from the spirit and scope of the invention.

What is claimed is:

1. A product comprising:
a fuel component having a hydrophilic coating over at least a portion thereof, the hydrophilic coating comprising nanoparticles comprising titanium oxide or titanium containing compounds derived therefrom.

2. A product as set forth in claim 1 wherein the nanoparticles have a size ranging from 10 to about 50 nm.

3. A product as set forth in claim 1 wherein substantially all of the nanoparticles have a size ranging from 10 to about 50 nm.

4. A product as set forth in claim 1 wherein the fuel cell component comprises a substrate comprising a metal.

5. A product as set forth in claim 1 wherein the fuel cell component comprises a substrate comprising a stainless steel.

6. A product as set forth in claim 1 wherein the fuel cell component comprises a bipolar plate.

7. A product as set forth in claim 6 wherein the bipolar plate has a reactant gas flow field defined in a surface thereof by a plurality of lands and channels and wherein the coating is over the lands and channels.

8. A product as set forth in claim 6 wherein the bipolar plate has a reactant gas flow field defined in a surface thereof by a plurality of lands and channels and wherein the coating is over the channels but not the lands.

9. A product as set forth in claim 1 wherein the coating further comprises a dopant to make the coating electrically conductive.

10. A product as set forth in claim 1 wherein the coating comprises TiOₓN_{y-1}.

11. A product as set forth in claim 6 further comprising a gas diffusion media layer underlying the bipolar plate.

12. A product as set forth in claim 11 further comprising an electrode underlying the gas diffusion medium.

13. A product as set forth in claim 12 further comprising a polymer electrolyte membrane underlying the electrode.

14. A product comprising:
a polymer electrolyte membrane comprising a first face and a second face;
a cathode electrode over the first face of the polymer electrolyte membrane;
a first gas diffusion media layer over the cathode electrode;
an anode electrode over the second face of the polymer electrolyte;
a second gas diffusion medium layer over the anode electrode;
a first fuel cell bipolar plate comprising a first face and a reactant gas flow field defined in the first face, the reactant gas flow field comprising a plurality of lands and channels, wherein the first fuel cell bipolar plate, a hydrophilic coating over at least a portion the first face of the a first fuel cell bipolar plate, the hydrophilic coating comprising nanoparticles comprising titanium oxide or titanium containing compounds derived therefrom;
a second fuel cell bipolar plate comprising a first face and a reactant gas flow field defined in the first face, the reactant gas flow field comprising a plurality of lands and channels, wherein the second fuel cell bipolar plate, a hydrophilic coating over at least a portion the first face of the a first fuel cell bipolar plate, the hydrophilic coating comprising nanoparticles comprising titanium oxide or titanium containing compounds derived therefrom.

15. A product as set forth in claim 14 wherein the coating is only over the channels of the first and second bipolar plate.

16. A product as set forth in claim 14 wherein the nanoparticles have a size ranging from 10 to about 50 nm.

17. A product as set forth in claim 14 wherein substantially all of the nanoparticles have a size ranging from 10 to about 50 nm.

18. A product as set forth in claim 14 wherein the fuel cell component comprises a substrate comprising a metal.

19. A product as set forth in claim 14 wherein the coating further comprises a dopant to make the coating electrically conductive.

20. A method comprising:
providing a fuel cell bipolar plate having a reactant gas flow field defined by a plurality of lands and channels in a surface of the bipolar plate;
depositing a hydrophilic coating on the cleaned surface, the hydrophilic coating comprising nanoparticles comprising titanium oxide or titanium containing compound derived therefrom.

21. A method as set forth in claim 20 further comprising cleaning at least a portion of the surface to prove a cleaned surface for subsequent deposition of a hydrophilic coating comprising nanoparticles comprising titanium oxide or titanium containing compound derived therefrom.

22. A method as set forth in claim 21 wherein the cleaning comprises wiping the surface with acetone and thereafter wiping the surface with methanol.

23. A method as set forth in claim 22 wherein the cleaning further comprises plasma cleaning the surface after the wiping the surface with methanol.

24. A method as set forth in claim 23 wherein the plasma cleaning comprises using open air plasma.

25. A method as set forth in claim 20 wherein the depositing a hydrophilic coating on the cleaned surface comprises at least one of brushing, spraying, doctor blading, depositing by electrophoresis a coating mixture comprising nanoparticles comprising titanium oxide or titanium containing compound derived therefrom.

26. A method as set forth in claim 20 wherein the depositing a hydrophilic coating on the cleaned surface comprises spraying robotically controlled microjets of a coating mixture from a plasma cleaning tool, the coating comprising nanoparticles comprising titanium oxide or titanium containing compound derived therefrom.

27. A method set forth in claim 23 further comprising providing the coating comprising suspending nanoparticle comprising titanium oxide in ethanol solution.

28. A method set forth in claim 27 where in the ethanol in the coating mixture is present in an amount sufficient to reduce surface tension of substrate to allow for more uniform coating on the substrate.

29. A method set forth in claim 20 wherein no cleaning of the bipolar plate is conducted prior to depositing the hydrophilic coating, and wherein the depositing comprises using an ethanol based mixture comprising nanoparticles comprising the titanium oxide or titanium containing compound derived therefrom.
